(19) United States
(12) Patent Application Publication
(10) Pub. No.: US 2023/0025723 A1
(43) Pub. Date: Jan. 26, 2023

(54) METHOD FOR ASSESSING AN EXTERNAL EVENT ON AN AUTOMOTIVE GLAZING

(71) Applicant: AGC GLASS EUROPE, Louvain-la-Neuve (BE)

(72) Inventors: Tingting LIU, Gosselies (BE); Arnaud ISERENTANT, Vieux-Genappe (BE); Maxime COLLIGNON, Gottignies (BE); Hermann LELONG, Gosselies (BE); Nicolas CHORINE, Haasrode (BE)

(73) Assignee: AGC GLASS EUROPE, Louvain-la-Neuve (BE)

(21) Appl. No.: 17/768,687

(22) PCT Filed: Oct. 9, 2020
(86) PCT No.: PCT/EP2020/078490

§ 371 Date: Apr. 13, 2022

(30) Foreign Application Priority Data
Oct. 18, 2019 (EP) 19204093.9

(51) Int. Cl. G01H 1/04; B32B 17/10; G01N 21/958

(52) U.S. Cl. CPC G01H 1/04; B32B 17/10009; G01N 21/958

(57) ABSTRACT

A method for detection and analysis of an external event occurring on an automotive glazing that includes receiving a signal with characteristic information of at least one electrical signal resulting from an occurrence of the external event on the automotive glazing. The method further includes applying the signal with characteristic information to a computer-implemented classification model, where for each of one or more quantities related to the characteristic information, a prediction is made of a value of a parameter indicative of the external event. The method further includes deriving a decision on whether to replace or repair based on the value of the parameter from the predictions.

### FIELD OF THE INVENTION

The present invention is generally related to the field of glazing sensors adapted for detecting vibration on glazing of a vehicle. More in particular, it relates to methods and systems to derive a decision on the effect on the glazing of an external event.

### BACKGROUND OF THE INVENTION

In the art, glazing sensors are known that can estimate the effect of an external event affecting the glazing of a vehicle, e.g. an impact on the glazing. Such an impact may result in a defect of the glazing which can be repaired or it may result in a defect, e.g. glass breakage, which requires replacement of the glazing.

The problem of glass breakage in vehicles should not be underestimated. Glass breakage leads to increasing costs and vehicle downtime. It is estimated that the replacement cost is increasing by 5% each year due to the growing penetration of so-called Advanced Driving Assistance Systems, whereby cameras are attached to the windshield. Preventive maintenance helps, but is nowadays definitely not yet used at its full potential. A majority of windshield replacements can be avoided by repairing glass damage preventively. Maintenance by windshield repair is 5 to 10 times cheaper and 3 to 5 times faster than windshield replacement.

In both cases it is important that the person responsible for maintaining the glazing is aware of the consequences of an impact and can derive therefrom which measures should be taken. Hence, such person needs to have information available as much and as accurate and fast as possible to take a decision.

In the prior art, systems have been presented comprising sensors which are able to communicate information on the impact. Such information allows determining the measures to be taken to repair the glazing after the impact or deciding on replacement. This information is usually communicated in an automated way.

A glazing sensor is typically arranged for detecting vibration of an automotive glazing. It may for example be a windscreen sensor. The glazing sensor comprises one or more vibration sensors and a communication module. The vibration sensor converts a vibration of the glass into an electrical signal and the communication module is capable of transmitting a signal comprising information that characterizes the electrical signal. Each such signal containing characteristic information can next be used for further analysis and to give predictions to help for decision taking.

There is however a need for techniques for deriving from the characteristic information a reliable decision on the effect of an event on the glazing.

### SUMMARY OF THE INVENTION

It is an object of embodiments of the present invention to provide for a method to detect and analyse one or more parameters that provide an indication of the effect an external event has had on an automotive glazing and to come to a decision on the need to repair the damage or replace the glazing or do nothing. The glazing is preferably a windshield.

The above objective is accomplished by the solution according to the present invention.

In a first aspect the invention relates to a method for detection and analysis of an external event occurring on an automotive glazing. The method comprises:

receiving a signal comprising characteristic information of at least one electrical signal resulting from an occurrence of the external event on the automotive glazing,

applying the signal comprising the characteristic information to a computer-implemented classification model, whereby for each of one or more quantities related to the characteristic information a prediction is made of a value of a parameter indicative of the external event,

deriving a decision on replacing or repairing based on said value of said parameter from said predictions.

The proposed solution indeed allows for assessing the effect of an external event has had on the automotive glazing. A signal is received containing information that characterizes the electrical signal observed after occurrence of the event. In the approach of this invention the signal with the characteristic information is fed into a computer-implemented classification model. Either the characteristic information already comprises one or more quantities or one or more quantities are determined from the characteristic information. For each of the quantities, a prediction is made for the considered parameter indicative of the event. From those predictions a decision on replacing or repairing the automotive glazing is then derived.

In a preferred embodiment the external event is an impact.

Preferably the characteristic information is the electrical signal itself, a digital version of the electrical signal or a frequency domain representation of the digital version of the electrical signal.

In one embodiment the one or more quantities are calculated from the characteristic information.

In embodiments, the parameter is the location according to X and Y coordinates and/or a simplified classification, i.e. between windshield driver zone and passenger zone of the external event.

In other embodiments a measure of the severity (i.e. no damage, surface pit, localized chip, crack) of the external event is the parameter.

In a preferred embodiment the computer-implemented classification model is selected among a random forest algorithm, support vector machine algorithm or a neural network.

In another embodiment the method comprises comprising an initial step of collecting data to train said classification model.

In one embodiment the method for detection and analysis comprises training the classification model using data stored in a database.

In another aspect, the invention relates to a program, executable on a programmable device containing instructions which, when executed, perform the method as previously described.

For purposes of summarizing the invention and the advantages achieved over the prior art, certain objects and advantages of the invention have been described herein above. Of course, it is to be understood that not necessarily all such objects or advantages may be achieved in accordance with any particular embodiment of the invention. Thus, for example, those skilled in the art will recognize that the invention may be embodied or carried out in a manner that achieves or optimizes one advantage or group of advantages as taught herein without necessarily achieving other objects or advantages as may be taught or suggested herein.

The above and other aspects of the invention will be apparent from and elucidated with reference to the embodiment(s) described hereinafter.

### BRIEF DESCRIPTION OF THE DRAWINGS

The invention will now be described further, by way of example, with reference to the accompanying drawings, wherein like reference numerals refer to like elements in the various figures.

FIG. 1 illustrates a possible implementation of a glazing sensor.

FIG. 2 illustrates a system with a glazing sensor, a gateway and a further computing device.

FIG. 3 illustrates an embodiment of the proposed method for obtaining a decision on impact location and/or impact severity.

### DETAILED DESCRIPTION OF ILLUSTRATIVE EMBODIMENTS

The present invention will be described with respect to particular embodiments and with reference to certain drawings but the invention is not limited thereto but only by the claims.

Furthermore, the terms first, second and the like in the description and in the claims, are used for distinguishing between similar elements and not necessarily for describing a sequence, either temporally, spatially, in ranking or in any other manner. It is to be understood that the terms so used are interchangeable under appropriate circumstances and that the embodiments of the invention described herein are capable of operation in other sequences than described or illustrated herein.

It is to be noticed that the term “comprising”, used in the claims, should not be interpreted as being restricted to the means listed thereafter; it does not exclude other elements or steps. It is thus to be interpreted as specifying the presence of the stated features, integers, steps or components as referred to, but does not preclude the presence or addition of one or more other features, integers, steps or components, or groups thereof. Thus, the scope of the expression “a device comprising means A and B” should not be limited to devices consisting only of components A and B. It means that with respect to the present invention, the only relevant components of the device are A and B.

Reference throughout this specification to “one embodiment” or “an embodiment” means that a particular feature, structure or characteristic described in connection with the embodiment is included in at least one embodiment of the present invention. Thus, appearances of the phrases “in one embodiment” or “in an embodiment” in various places throughout this specification are not necessarily all referring to the same embodiment, but may. Furthermore, the particular features, structures or characteristics may be combined in any suitable manner, as would be apparent to one of ordinary skill in the art from this disclosure, in one or more embodiments.

Similarly it should be appreciated that in the description of exemplary embodiments of the invention, various features of the invention are sometimes grouped together in a single embodiment, figure, or description thereof for the purpose of streamlining the disclosure and aiding in the understanding of one or more of the various inventive aspects. This method of disclosure, however, is not to be interpreted as reflecting an intention that the claimed invention requires more features than are expressly recited in each claim. Rather, as the following claims reflect, inventive aspects lie in less than all features of a single foregoing disclosed embodiment. Thus, the claims following the detailed description are hereby expressly incorporated into this detailed description, with each claim standing on its own as a separate embodiment of this invention.

Furthermore, while some embodiments described herein include some but not other features included in other embodiments, combinations of features of different embodiments are meant to be within the scope of the invention, and form different embodiments, as would be understood by those in the art. For example, in the following claims, any of the claimed embodiments can be used in any combination.

It should be noted that the use of particular terminology when describing certain features or aspects of the invention should not be taken to imply that the terminology is being re-defined herein to be restricted to include any specific characteristics of the features or aspects of the invention with which that terminology is associated.

In the description provided herein, numerous specific details are set forth. However, it is understood that embodiments of the invention may be practiced without these specific details. In other instances, well-known methods, structures and techniques have not been shown in detail in order not to obscure an understanding of this description.

The present invention proposes a method to detect and analyse an external event like e.g. an impact on an automotive glazing and to exploit the result thereof to take a decision on the need to either repair the damage or replace the glazing or do nothing.

A set-up is considered wherein a glazing sensor is mounted against the surface of an automotive glazing, typically at a border of the glazing, and comprises one or more vibration sensors, e.g. piezoelectric vibration sensors, that each convert a vibration of the glass into a corresponding electrical signal. The glazing sensor may comprise an analog to digital converter for converting the electrical signal from the vibration sensor into a digital signal. The glazing sensor may comprise a processing unit to perform processing on the obtained electrical signal. Another option is that the processing on the electrical signal can be performed remotely on another computing device. Alternatively, part of the processing may be done locally in the glazing sensor and part may be done remotely. A signal is derived containing characteristic information of the electrical signal. The characteristic information may be the electrical signal itself or it may be a filtered and/or digitized and/or a processed version of the electrical signal. The characteristic information may be derived by introducing a threshold level, so that only a relevant signal situation is kept and signals from the vibration sensor(s) are ignored when they are too small, i.e. below the threshold level. For example it may be the amplified electrical signal, the Fast Fourier Transform (FFT) of the digitized electrical signal, minimum and/or maximum value of the digitized time-domain electrical signal. The sensor further comprises a communication module capable of transmitting the signal containing characteristic information of the electrical signal. Also the optional threshold may be passed when an external event such as an impact occurs. A record of all sensors may be made for a given time after the external event. These signals are called the “traces”. As mentioned above, these traces can be processed locally or externally.

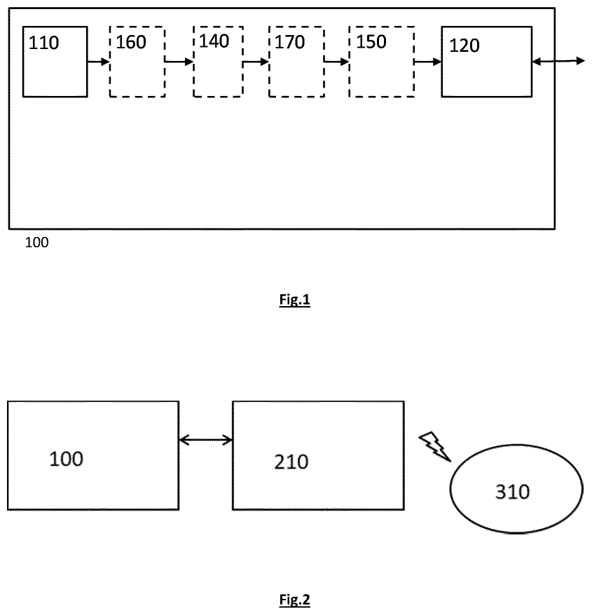

A possible implementation of a glazing sensor is illustrated in FIG. 1. The figure schematically shows different additional building blocks which may or may not be present in the considered glazing sensor 100. A filter and/or amplifier 160 may be present for filtering and/or amplifying the electrical signal of the vibration sensor 110. The electrical signal or the filtered and/or amplified electrical signal may be converted into a digital signal by an A/D converter 140. A digital filter 170 may filter the digital signal of the A/D converter. The glazing sensor may comprise a processing module 150 adapted for processing the digital signal before transmitting the processed signal with the communication module. The processing module 150 may for example be a microcontroller, a microprocessor, a field programmable gate array, etc. Such preprocessing may for example be advantageous as less data may need to be transmitted, thus reducing the required bandwidth. The communication module 120 is adapted for wirelessly transmitting a signal comprising characteristic information of the electrical signal. It may for example receive this signal from the processing module 150.

The filter 160 may for example be a high pass filter which is applied to the electrical signal from the vibration sensor 110. This allows eliminating the low frequency noise related to unwanted effects. In case the vehicle is a car, bus, or truck this noise may for example be engine noise, wheels and road noise, music, etc.

The optional building block 160 may be adapted for amplifying the electrical signal. This amplification may for example increase the signal level from tens or hundreds of millivolts to levels compatible with standard analog to digital conversion stages typically of 0 to 5V.

The communication module may comprise a wide range of possible components to communicate with other devices, like e.g. LTE chips, Bluetooth chips (for example to use Bluetooth Low Energy (BLE) as radio technology), Sim card readers, antennas etc. The communication module may allow the glazing sensor to communicate directly with a server/cloud infrastructure, for instance by using the cellular network. As stated above, the communication module may use short range communication technology such as BLE. In this case, the glazing sensor needs another device to relay its messages to the server/cloud infrastructure. This additional device is called a gateway throughout this description. It features one or more communication modules allowing, on the one hand, for short range communications with the glazing sensor (for instance through BLE) and, on the other hand, for long range communications with a server/cloud infrastructure (for instance through cellular communication). The gateway may be powered by the vehicle. In case of a car such a device may be connected to the on-board diagnostics (OBD) port, on a cigarette lighter adapter or a USB port. The gateway may also be implemented through an application on the driver's smartphone.

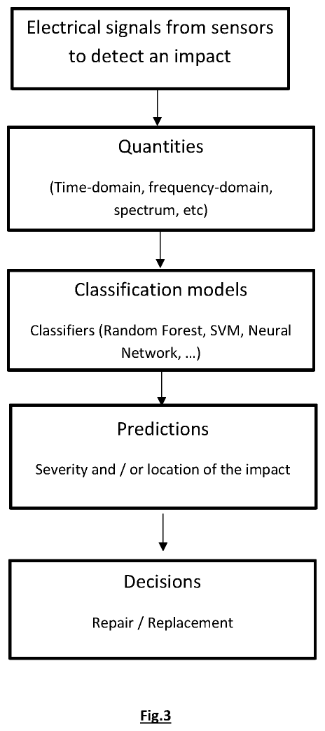

As already mentioned, it may also be that the raw electrical sensor signals, or only partially processed electrical signals, are transmitted using the communication module (e.g. by means of LTE, Bluetooth, etc.) and possibly a gateway, to another computing device, e.g. a storage and processing unit which may for example reside in the cloud. FIG. 2 provides an illustration of a system comprising a glazing sensor 100, a gateway 210 to relay the signal received from the communication module in the glazing sensor and a computing device 310 which receives the relayed signal and stores and processes the received signal. The computing device 310 may be a portable computer or a server/cloud infrastructure, available on the Internet, that provides enough computation resources to analyze the data and provides storage for the data.

The gateway 210 is adapted to relay the signal (e.g. data) from the communication module 120 in the glazing sensor 100 to the computing device 310. The gateway device 210 may therefore receive data from the communication module 210 via a wireless communication link such as a Bluetooth communication link. The gateway 210 typically has access to the internet, generally through a mobile communication module. It may transmit the data to the computing device 310 over a long range communication technology, or a cellular communication network, such as a GSM network, an EDGE network, a 3G network, or an LTE network.

Now that the communication infrastructure which is needed for applying the methods of the present invention has been described, the algorithmic approach adopted in those methods is described in detail. The disclosed technique exploits characteristic information obtained from the electrical signal to determine the effect an external event has had on the automotive glazing. This external event may for example be the impact of an object on the glazing or the friction of a worn glazing wiper or any other external event generating an usable electrical signal according to the present invention. As detailed below, starting from this characteristic information of the electrical signal it may for example be possible to distinguish between a breakage/non breakage (or damage) situation or to get an idea of the location where an impact occurred. Based on this analysis a decision can then be taken on a repair or replacement (or not) of the glazing.

In the approach of the invention information relevant for the decision-making process has been stored in a data set. The data set may be stored in a server/cloud infrastructure. Alternatively, the data set can be stored in the glazing sensor or in a portable computing device. In an embodiment of the method of the invention the data belonging to the data set may have been collected in an optional initial step. In embodiments the data set is already made available upfront. The data collection phase has then been performed much earlier. The data set, also referred to as database hereinafter, comprises data on the effect of the considered external event on the vehicle glazing, e.g. the effect of an impact on the vehicle's windshield. The data may be raw sensor data, e.g. a voltage signal measured (sensed) in response to a vibration caused by e.g. an impact. As set out above, there may have been some processing performed on the data prior to storing the data in the database. This processing may be performed in the glazing sensor in certain cases, but in other cases it can be performed in an external portable computing device or in a server/cloud infrastructure. To collect the data, a plurality of measurements may be performed whereby each time an impact is generated at a different location on the windshield of the vehicle. The amplitude (force) of the impact may differ over the measurements. The data collection may in certain embodiments be performed in an automatic way based on a dedicated software program. A glazing sensor 100 is preferably located near an edge of the windshield and comprises two vibration sensors. For impact location detection at least two vibration sensors are needed. Having more than two sensors is advantageous for obtaining higher precision in the location determination. The positioning of the glazing sensor may be placed to divide the surface of the windshield in two parts such as a first part of the glazing in front of the driver and another subregion formed by the remaining part of the glazing. According to the present invention, the glazing sensor may further locate an impact according to X and Y coordinates and/or a simplified classification, i.e. between windshield driver zone and passenger zone. The measured signal indicative of the sensed vibration due to the impact on that location is then added to the database, possibly after having undergone some processing to obtain characteristic information which either already comprises one or more quantities to be used in the algorithm or allows computing said one or more quantities in a computing device.

The data stored in the database may be raw data (the measured data obtained as output of the vibration sensor(s)) and/or data derived from the raw data, e.g. a frequency domain representation of the measured signal(s) (e.g. a Fast Fourier transform), one or more statistical features like minimum, maximum, average and standard deviation, power. This is further detailed in the embodiments described below.

The obtained database is next used to train a computer-implemented classification model for a given parameter of the external event, e.g. the location of an impact and/or the severity of an impact. This can be based on any machine learning algorithm suitable for classification as known in the art. One example is a random forest algorithm. Other examples may be a support vector machine or a neural network. It should be noted however that these are merely examples and that in principle any binary classification algorithm can be a candidate for use in the method of this invention.

Random forests are an ensemble learning method for classification, regression and other tasks that operates by constructing a multitude of decision trees at training time and outputting the class that is the mode of the classes (classification) or mean prediction (regression) of the individual trees.

Alternatively, support vector machines or neural networks can be applied. Support vector machines (SVM) are supervised learning models with associated learning algorithms that analyse used for classification and regression analysis. A neural network is a network composed of artificial neurons or nodes for solving artificial intelligence problems. Such an artificial network is well-known in the art and can be used for predictive modelling, adaptive control and applications where they can be trained via a dataset. Self-learning resulting from experience can occur within the network, which can derive conclusions from a complex and seemingly unrelated set of information. Classification, including pattern and sequence recognition, is an important application field of neural networks.

Embodiments are now detailed wherein the external event is an impact on the glazing. First the location of the impact is considered as the parameter to be decided on. The surface of the automotive glazing is for example split into two subregions. The glazing sensor 100 comprising two vibration sensors, e.g. piezoelectric sensors, is placed near a border of the glazing so that it does not hinder the driver. One vibration sensor is positioned in the first subregion, whereas the other vibration sensor is in the other subregion. For example, a first subregion corresponds to a part of the glazing in front of the driver. The other subregion then is formed by the remaining part of the glazing. It is advantageous to make the part of the glazing in front of the driver a separate subregion: an impact there may require attention more urgently than an impact in the other subregion. This is also the reason why preferably the border between the two subregions is not in the middle of the windshield, but rather more towards the driver side. One aims to cover the critical area for the driver in one subregion. It is understood that the glazing sensor 100 may comprise more than two vibration sensors to cover several subregions of the windshield (or more generally a glazing) and collect more data.

FIG. 3 illustrates the further steps in embodiments of the method directed towards determining the most likely impact location and/or the severity of the impact (no damage, surface pit, localized chip, crack. For the impact location, at least two quantities are derived from the electrical signals generated by the glazing sensor 100. Obviously, in other preferred embodiments more than two quantities can be determined in any combination. The quantities, expressed in Volts, may be for example as follows:
The time domain representation of the signals
The time delay calculated by cross-correlation of the signals
The frequency domain representation (by means of e.g. an FFT) of the signals
The signal power derived from the at least one signal
The power spectral density
. . .

In one embodiment, the method is applied to have a prediction on the location of an impact on an automotive glazing. For each of the quantities a prediction on the location where the impact has occurred is obtained via a classification model, also called Machine learning model, i.e. an output label indicating X and Y coordinates of the impact and/or a subregion of the glazing where the impact occured. From these predictions one can already reach a decision to replace or repair the windshield. However, in order to further improve the quality of the decision to be taken, the various predictions are then advantageously again input to a classification model, e.g. a random forest, to result in a more confident prediction of the location parameter. Alternatively another classification model can be applied.

It is repeated that in certain embodiments the quantities can be calculated within the glazing sensor. In that case the communication module transmits a signal comprising the characteristic information, including the (one or more) quantities that have been calculated. In other embodiments the signal transmitted by the communication module may be the electrical signal itself and the one or more quantities are calculated externally, e.g. in a server/cloud infrastructure or in an external, e.g. portable, computing device which receives the signal from the communication module at its input and next performs the computational tasks required to obtain the desired quantities. In yet other embodiments a part of the processing may be performed in the glazing sensor and a part in an external computing device. Also for running the classification model and performing the algorithm as a whole the same options are available: it can be performed in the glazing sensor itself (in a stand-alone implementation for example), in a server/cloud infrastructure or in an external, e.g. portable, computing device.

Now embodiments are presented wherein the parameter is the severity of the external event. Again the external event is considered to be an impact on the glazing. In this case the data set may also contain data for various types of glazing. For each measurement it may also be kept in the database whether the impact has led to breakage or not.

The FIG. 3 is also applicable to a method directed towards assessing the severity of the impact. Quantities, as i.e. the time domain representation and/or frequency domain representation (by means of e.g. an FFT) and/or the power spectral density (PSD) and/or related quantities, as i.e. the cross-correlation between multiple signals are derived from the at least one electrical signal. These quantities are then fed to a classification model. The outcome of the classification model is a value now indicating whether, based on the respective quantity, there is a damage of the glazing or not. The predicted value can be further used to obtain an information as the damage type, i.e. surface pit, hertz chip, median chip, crack or any damage on the windshield generating an electrical signal. This information is then used to decide if the glazing can be repaired or needs replacement. In order to improve the quality of the prediction, several predicted values are advantageously input to a classification model, to yield an improved conclusion on the impact severity. From that information it can then be decided whether there is a need to repair or replace the glazing.

In another embodiment of the solution, predictions on location and severity of an impact on an automotive glazing are combined as an improved information leading to an improved decision whether there is a need to repair or replace the glazing.

While the invention has been illustrated and described in detail in the drawings and foregoing description, such illustration and description are to be considered illustrative or exemplary and not restrictive. The foregoing description details certain embodiments of the invention. It will be appreciated, however, that no matter how detailed the foregoing appears in text, the invention may be practiced in many ways. The invention is not limited to the disclosed embodiments.

Other variations to the disclosed embodiments can be understood and effected by those skilled in the art in practicing the claimed invention, from a study of the drawings, the disclosure and the appended claims. In the claims, the word “comprising” does not exclude other elements or steps, and the indefinite article “a” or “an” does not exclude a plurality. A single processor or other unit may fulfil the functions of several items recited in the claims. The mere fact that certain measures are recited in mutually different dependent claims does not indicate that a combination of these measures cannot be used to advantage. A computer program may be stored/distributed on a suitable medium, such as an optical storage medium or a solid-state medium supplied together with or as part of other hardware, but may also be distributed in other forms, such as via the Internet or other wired or wireless telecommunication systems. Any reference signs in the claims should not be construed as limiting the scope.

1. A method for detection and analysis of an external event occurring on an automotive glazing, the method comprising:
receiving a signal comprising characteristic information of at least one electrical signal resulting from an occurrence of the external event on the automotive glazing;
applying the signal comprising characteristic information to a computer-implemented classification model, whereby for each of one or more quantities related to the characteristic information a prediction is made of a value of a parameter indicative of the external event; and
deriving a decision on whether to replace or repair based on the value of the parameter from the predictions.

2. The method for detection and analysis according to claim 1, wherein the external event is an impact or another mechanical stress on the automotive glazing.

3. The method for detection and analysis according to claim 1, wherein the signal is received from a vibration and/or an acoustic sensor.

4. The method for detection and analysis according to claim 1, wherein the characteristic information is the electrical signal itself, a digital version of the electrical signal or a frequency domain representation of the digital version of the electrical signal.

5. The method for detection and analysis according to claim 1, wherein the one or more quantities are calculated from the characteristic information.

6. The method for detection and analysis according to claim 1, wherein the parameter is a location of the external event.

7. The method for detection and analysis according to claim 1, wherein the parameter is a measure of a severity of the external event.

8. The method for detection and analysis according to claim 1, wherein the computer-implemented classification model is selected from a group consisting of a random forest algorithm, a support vector machine algorithm and a neural network.

9. The method for detection and analysis according to claim 1, further comprising initially collecting data to train the computer-implemented classification model.

10. The method for detection and analysis according to claim 1, comprising training the computer-implemented classification model using data stored in a database.

11. A program, executable on a programmable device containing instructions which, when executed, perform the method according to claim 1.
